(19) United States
(12) Patent Application Publication
(10) Pub. No.: US 2019/0393609 A1
(43) Pub. Date: Dec. 26, 2019

(54) Wire Retention-Enabling Wire Carriers

(71) Applicant: Remarkable Technologies, Inc., Avon, CT (US)

(72) Inventors: Eric A. Knight, Unionville, CT (US); Rodney J. Lane, Southington, CT (US)

(21) Appl. No.: 16/564,828

(22) Filed: Sep. 9, 2019

Related U.S. Application Data
(63) Continuation-in-part of application No. 15/641,595, filed on Jul. 5, 2017, now Pat. No. 10,468,762.
(60) Provisional application No. 62/729,005, filed on Sep. 10, 2018.
(60) Provisional application No. 62/411,838, filed on Oct. 24, 2016.

(51) Int. Cl. H01Q 11/00

(52) U.S. Cl. CPC H01Q 11/00

(57) ABSTRACT

A wire carrier is provided herein, which can include a length of insulative material, wherein the insulative material comprises one or more wire-retaining features, wherein the one or more wire-retaining features include at least one predetermined arrangement of notches in the insulative material, and wherein the one or more wire-retaining features enable retention of at least one wire in at least one predetermined, non-linear pattern.

### CROSS-REFERENCE TO RELATED APPLICATIONS

The present application claims priority to U.S. Provisional Patent Application Ser. No. 62/729,005, filed Sep. 10, 2018, which is incorporated by reference herein.

The present application is also a continuation-in-part of U.S. patent application Ser. No. 15/641,595, filed Jul. 5, 2017, entitled “Versatile Antenna Wire and Methods of Manufacturing,” which claims priority to U.S. Provisional Patent Application Ser. No. 62/411,838, filed Oct. 24, 2016, both of which are incorporated by reference herein. In addition, the present application is related to U.S. Pat. No. 7,864,131, filed Nov. 29, 2007, which is also incorporated by reference herein.

### FIELD OF INVENTION

The field relates generally to antenna design, and more particularly to wire carriers.

### BACKGROUND

Antennas made of wire are the oldest type of antenna system. They are generally easy to construct, but, particularly on frequencies below very high frequency (VHF) threshold (below 30 MHz, for example), the required length of the wire can be inconvenient or not practical for the space available for their construction and/or use. Additionally, one challenge with such types of antenna is that tension is created throughout the entire system, including the wire elements, and over time, it is common for the wire to stretch and break; thus requiring the wire element(s) to be repaired or replaced.

Also, in a typical electrical wire (such as, for example, a lamp cord), the wires are used to pull the extrusion through the extruder. However, in certain designs, the wires must remain at specific angles or positions, and therefore the wires cannot be used to pull the extrusion without risking damage to the desired wire configuration and/or positioning.

Another challenge commonly facing antenna design is that creating an antenna design using existing approaches is commonly a time-consuming and labor-intensive task. For example, via such existing approaches, it can be tedious to precisely bend a wire and affix potentially many wire positions to a support rope.

### SUMMARY

In one or more embodiments, wire retention-enabling wire carriers are provided. In one such an embodiment, a wire carrier includes a length of insulative material, wherein the insulative material comprises one or more wire-retaining features, wherein the one or more wire-retaining features comprises at least one predetermined arrangement of notches in the insulative material, and wherein the one or more wire-retaining features enable retention of at least one wire in at least one predetermined, non-linear pattern.

In another such embodiment, a wire carrier includes a length of insulative material, wherein the insulative material comprises one or more wire-retaining features, wherein the one or more wire-retaining features comprises at least one predetermined arrangement of hemispherical tabs in the insulative material, and wherein the one or more wire-retaining features enable retention of at least one wire in at least one predetermined, non-linear pattern.

In yet another such embodiment, a wire carrier includes a length of insulative material, wherein the insulative material comprises one or more wire-retaining features, wherein the one or more wire-retaining features comprises at least one predetermined arrangement of circular holes in the insulative material, and wherein the one or more wire-retaining features enable retention of at least one wire in at least one predetermined, non-linear pattern.

### BRIEF DESCRIPTION OF THE DRAWINGS

FIG. 1 shows an illustration of a triangle wave in accordance with an example embodiment.

FIG. 2 shows an integrated construction of a triangle wave and a polymer carrier, in accordance with an example embodiment.

FIG. 3 shows a notched wire carrier in accordance with an example embodiment.

FIG. 4 shows a tabbed wire carrier in accordance with an example embodiment.

FIG. 5 shows a hole-based wire carrier in accordance with an example embodiment.

### DETAILED DESCRIPTION

As described herein, one or more embodiments include a retaining mechanism-based wire carrier in which a user can retain his or her choice of wire in a particular pattern (for example, a zigzag pattern). Additionally, in accordance with one or more embodiments, the wire would not need to be protected from the environment. Also, by way merely of example, copper wire, which holds up well when not under tension, can be utilized in conjunction with one or more embodiments. Other electrical conductors that can be utilized in conjunction with one or more embodiments can include, for example, formed foil, die-cut foil, thin metal, printed conductive materials, electrically conductive ink, electrically conductive coatings, electrically conductive polymers, etc.

As noted above, this application is related to U.S. patent application Ser. No. 15/641,595, filed Jul. 5, 2017, and is also related to U.S. Pat. No. 7,864,131, filed Nov. 29, 2007, both of which are incorporated by reference herein. Additionally, it is further noted that the article authored by Eric Knight, entitled “The Sabertooth Wire: An Innovation in Antenna-Length Shortening,” published in CQ Magazine in July 2018, is also incorporated by reference herein.

As described in the above-noted U.S. patent application Ser. No. 15/641,595, as well as the above-noted U.S. Pat. No. 7,864,131, at least one embodiment includes creating a triangle wave pattern, which combines easy construction and antenna-shortening performance, as well as creating other wave type patterns including sine wave patterns, square wave patterns, and sawtooth wave patterns.

Additionally, as detailed herein, one or more embodiments also include creating and implementing a wire-retaining mechanism. In accordance with one or more such embodiments, a wire can be run and/or positioned through a pre-formed pattern of a retaining mechanism. Such an embodiment can include the benefit of enabling a user to create an antenna much more quickly and efficiently than via existing approaches.

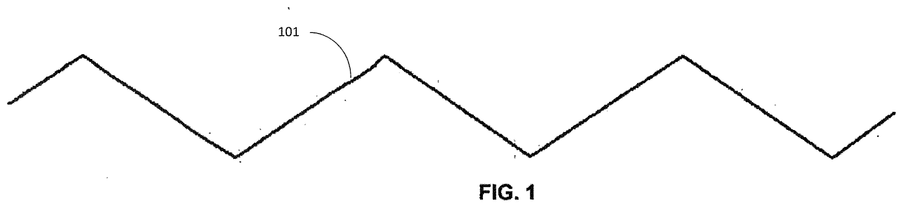

FIG. 1 shows an illustration of a triangle wave 101 in accordance with an example embodiment. As detailed herein, one or more embodiments include enabling an antenna wire to be formed into a repetitive wave shape. Examples of wave-shape options include a triangle wave (such as depicted in FIG. 1), a sine wave, a square wave, and a sawtooth wave. Each wave shape offers various performance and installation opportunities. By way merely of illustrative simplicity, one or more of the embodiments described and detailed herein are based on a triangle wave (such as wave 101 depicted in FIG. 1). However, it is to be appreciated that the scope of the invention includes and encompasses a variety of wave shapes, including sine waves, square waves, sawtooth waves, etc.

A typical implementation of an existing antenna design approach might include a length of wire formed into a continuous triangle wave shape, which is draped over a length of support rope. The wire, in such an implementation, is supported entirely by the rope at each triangle wave apex. The antenna wire can be divided (for example, at the midpoint wave valley), and a coax feed line can be attached to the ends of the wire created by the wire division.

Adjustments in the overall length of the antenna can be achieved by increasing or decreasing the angles that make up the triangles (in other words, by expanding or contracting the waves of the triangles in accordion-like fashion). Overall antenna lengths can thus be configured to match a user's needs and/or operational requirements. For instance, for a user desiring a very compact antenna, the angles of the triangles can be reduced to provide a reduction in overall antenna length (for example, a reduction of up to 80 percent or more), while still providing satisfactory operating and performance characteristics.

In one or more embodiment detailed herein, the wave shape(s) can be compressed in accordion-like fashion, providing an antenna system that can be shorter than traditional wire antennas. Thus, one or more embodiments can be adjusted and/or implemented to fit and function in just about any usable space.

As noted above, one of the most common failure modes of a traditional wire antenna is the stretching and snapping of wire elements, generally experienced as the wire elements bear supportive tensile load. An advantage of one or more embodiments detailed herein is that the wire elements are not under a tensile load. This advantage greatly expands the types of wires that can be used in antenna construction. For example, even smaller diameter wires and very fine wires that have low tensile strength can be utilized in one or more embodiments. Additionally, because the wires are not under tensile load, the useful life of an antenna system created via one or more embodiments can be dramatically extended.

Further, one or more embodiments do not require inductors, coils, or other inductive elements, which can reduce construction costs, reduce transmission and performance losses that can be incurred by the addition of inductive elements, and provide for greater antenna longevity. Similarly, one or more embodiments do not require end insulators or insulators at the feed point of the feed line, which can reduce construction and end-user costs, as well as reduce the number of potential failure points in the system.

As also detailed herein, at least one embodiment includes an integration of a wave-formed wire and a polymer carrier, wherein such an integration maintains the wire's waveform shape. As described here, such a wire can be referred to, for example, as being embedded in a protective, non-electrically conductive sheath. Further, in one or more embodiments, a wire-retaining mechanism wire carrier can be created and/or implemented. In such an embodiment, the wire-retaining mechanism wire carrier can but does not have to be initially integrated with a polymer carrier.

An example embodiment can include a wire or other electrically-conductive material formed in a pattern that is embedded in a protective, non-electrically conductive sheath. Such an embodiment is configured to reduce the length required to install an antenna while providing the performance of a physically longer or taller antenna. Additionally, in such an embodiment, the non-electrically conductive sheath, otherwise referred to herein as a structural element, can have a tensile strength sufficient to support the embedded formed wire between two mounting points. When such a non-electrically conductive sheath is of sufficient tensile strength to support the apparatus under tensile load, the wire is not under stress or strain. In other words, the apparatus does not rely on the wire to provide tensile strength in the application of the apparatus.

Further, in one or more embodiments, the non-electrically conductive sheath containing the formed wire can include one or more holes through its construction. In such an embodiment, a taut length of non-electrically conductive support line, threaded through the one or more holes, can provide support to eliminate stress or strain on the embedded wire.

Further still, in one or more embodiments, the non-electrically conductive sheath can have a greater tensile strength than the embedded wire, and can also have greater inherent shock-absorbing capability (providing beneficial resiliency during severe weather conditions, for example). It is to be appreciated by one skilled in the art that a range of materials may be employed to form a non-electrically conductive sheath encasing a formed wire or other formed conductor, and that such a sheath may also be a structural element. By way of example, various forms of rubber, castable or extrudable elastomeric polymers, thermally formed or bonded insulating materials, and composites can be used as non-electrically conductive materials.

As further detailed herein, at least one embodiment can be implemented in connection with an extrusion process of polyethylene to manufacture a wire-retaining mechanism. Additionally, in at least one embodiment, a non-electrically conductive polymer (such as polyethylene, for example) is extruded around the formed pattern of an electrically-conductive material.

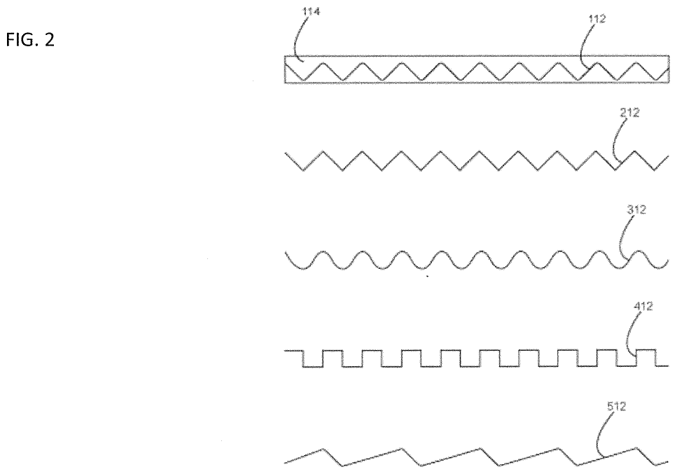

FIG. 2 shows an integrated construction of a triangle wave and a polymer carrier, in accordance with an example embodiment. FIG. 2 is a top view of various strips of versatile antenna wire comprised of electrically conductive material 112 in various configurations, including a triangle wave configuration 212, a sine wave configuration 312, a square wave configuration 412, and a sawtooth wave configuration 512, all designed to fit within a co-planar, protective, non-electrically conductive sheath 114.

As further described herein, at least one embodiment includes allowing radio-wave resonance to occur at much shorter end-to-end antenna-element lengths than are typically created. By way merely of example, on such embodiment can include implementing a triangle wave pattern with an apex angle between 23 degrees and 33 degrees (for example, 25 degrees), which results in an end-to-end reduction in antenna-wire length of approximately 50% for a given operating frequency. Also, by way of further example, one or more embodiments include implementing a wave pattern with an apex angle between 20 degrees and 135 degrees.

Additionally, at least one embodiment includes implementing two or more varying apex angles within a single antenna. Accordingly, such an embodiment can include non-consistent or varying wire-apex angles and/or pitch spacings to enhance and/or modify the distribution of antenna signal currents.

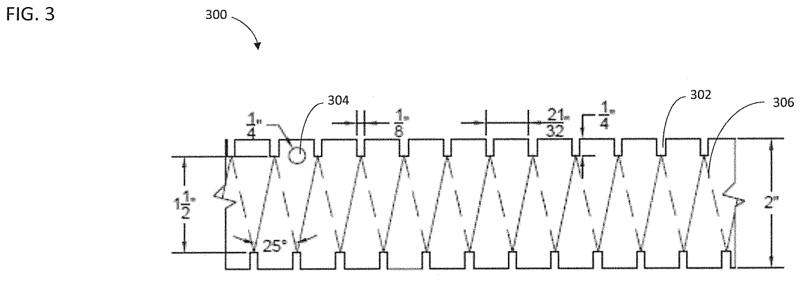

FIG. 3 shows a notched wire carrier 300 in accordance with an example embodiment. As noted herein, in accordance with one or more embodiments, wire 306 configured in one or more repetitive patterns allows for radio-wave resonance to occur at shorter end-to-end antenna-element lengths than are typically created. Such an embodiment includes enabling shortened end-to-end antenna-element lengths, which can be dependent on the wire angle created by the wire pattern. For instance, an example embodiment that includes an angle of approximately 25 degrees (as depicted in FIG. 3) can reduce the needed end-to-end antenna-element length by approximately 50%. Accordingly, it can be critical that the retaining mechanism detailed herein securely and continuously retains the applied antenna wire in the selected angle under various conditions. As antennas such as described in connection with one or more embodiments are used outdoors, the angle-retaining performance must withstand wind, rain, snow, ice, thermal cycling, etc.

Referring again to FIG. 3, the particular embodiment depicted is referred to herein as the notch embodiment. Such a notch embodiment can be created by a production process such as, for example, extrusion. The extruded material can include a variety of durable, insulative polymers (such as, for example, polyethylene). As such an antenna might commonly be used outdoors, such an embodiment can also include an ultraviolet (UV)-resistant polymer.

Additionally, as depicted in FIG. 3, the extruded material can be notched by an appropriate manufacturing die; in the particular embodiment depicted in FIG. 3, the die creates a repetitive sequence of a ⅛″×¼″ notches 302 that are 21/32″ apart. The same die, or one or more additional die, also punches support holes 304; in the particular embodiment depicted in FIG. 3, the die creates a repetitive sequence a ¼″ diameter support holes 304. The use of the support holes is further described below. Also, it is noted that for purposes of illustrative simplicity, the repetitive sequence of ¼″ diameter support holes 304, comprised of holes spaced apart (e.g., by 12″) along the length of the extrusion, is not shown in FIG. 3.

Further, in one or more embodiments, the thickness of the extruded polymer is variable. By way of example, the extruded polymer generally needs to be as thick as is necessary to securely form and retain the applied wire in the selected angle. The length of the extruded component can also be variable, and can be dependent on the desired length of the completed antenna element. Typically, the length can be of a range of approximately one foot to hundreds of feet.

Referring again to FIG. 3, the repetitive notches 302 guide and secure a wrapped-around length of wire 306. The path of the wire 306, as shown in FIG. 3, is indicated by the solid and dotted lines. The particular example embodiment depicted in FIG. 3 creates a wire pattern with a wire angle of 25 degrees, and provides the user with an end-to-end antenna-element that is approximately 50% shorter than would otherwise be typical.

Additionally, after the wire 306 is applied to the retaining mechanism and a completed antenna element is created, the finished construction can be supported via support holes 304. In one or more embodiments, for example, non-conductive carrier rope, cord, or monofilament can be threaded through the support holes, and the ends of the rope, cord, or monofilament are secured to fixed structures, such as masts or trees.

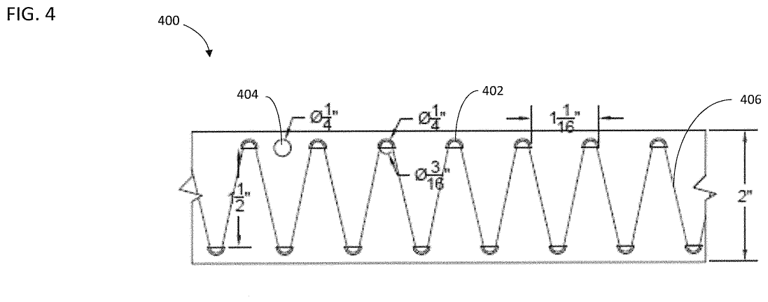

FIG. 4 shows a tabbed wire carrier 400 in accordance with an example embodiment. Similar to the description above in connection with the notched wire carrier embodiment depicted in FIG. 3, the embodiment depicted in FIG. 4, referred to herein as the tabbed embodiment, can also be created by a production process, such as extrusion. As illustrated in FIG. 4, the extruded material is tabbed by an appropriate manufacturing die; in the embodiment depicted in FIG. 4, the die creates a repetitive sequence of ¼″ diameter hemispherical tabs 402 that are 1 1/16″ apart. As noted above in connection with the notched embodiment, the same die, or an additional die, can also punch support holes 404.

As also depicted in FIG. 4, in the tabbed embodiment, the repetitive tabs 402 guide and secure a length of wire 406 in a waveform path; the path of the wire 406 is indicated by the solid lines in FIG. 4. This particular embodiment can also create a wire pattern with a wire angle of 25 degrees, and provide the user with an end-to-end antenna-element that is approximately 50% shorter than would otherwise be typical using existing approaches.

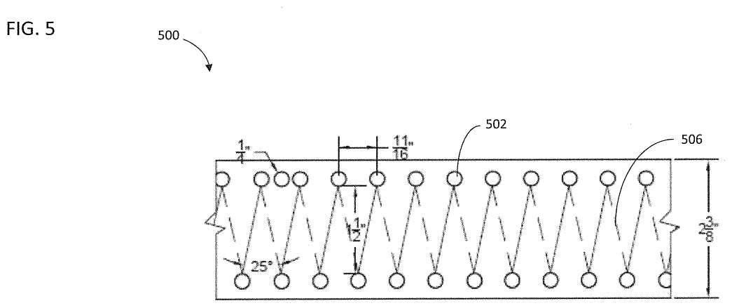

FIG. 5 shows a hole-based wire carrier 500 in accordance with an example embodiment.

Similar to the description above in connection with the notched wire carrier embodiment depicted in FIG. 3 (and the tabbed embodiment depicted in FIG. 4), the embodiment depicted in FIG. 5, referred to herein as the hole-based embodiment, can be created by a production process such as extrusion. The extruded material is punched with holes by an appropriate manufacturing die; in the particular embodiment depicted in FIG. 5, the die creates a repetitive sequence of ¼″ diameter wire-threading holes 502 that are 11/16″ apart.

In this particular embodiment, as illustrated in FIG. 5, the repetitive wire-threading holes 502 guide and secure a wire 506 that is threaded in and out of the holes 502 (much like, for example, laces of a shoe or sneaker); the path of the wire 506 is indicated in FIG. 5 by the solid and dotted lines. Similar to the FIG. 4 and FIG. 5 embodiments, the hole-based embodiment can also create a wire pattern with a wire angle of 25 degrees, and provide the user with an end-to-end antenna-element that is approximately 50% shorter than would otherwise be typical using existing approaches.

Accordingly, as detailed herein, one or more embodiments include generating and/or implementing wire retention-enabling wire carriers. In one such an embodiment, a wire carrier includes a length of insulative material, wherein the insulative material comprises one or more wire-retaining features, wherein the one or more wire-retaining features comprises at least one predetermined arrangement of notches in the insulative material, and wherein the one or more wire-retaining features enable retention of at least one wire in at least one predetermined, non-linear pattern.

In such an embodiment, the at least one predetermined arrangement of notches in the insulative material includes a sequence of approximately one-eighth (⅛) inch by one-quarter (¼) inch rectangular notches spaced approximately twenty-one thirty-seconds ( 21/32) inches apart. Also, in such an embodiment, the one or more wire-retaining features can include a sequence of approximately one-quarter (¼) inch support holes. In such an embodiment, the at least one predetermined, non-linear pattern includes an apex angle between approximately 20 degrees and approximately 135 degrees. Further, in such an embodiment, the at least one predetermined, non-linear pattern includes an apex angle between approximately 23 degrees and approximately 33 degrees (e.g., approximately 25 degrees). Also, in such an embodiment, the at least one predetermined, non-linear pattern includes two or more distinct apex angles and/or two or more distinct pitch spacing distances.

Additionally, in such an embodiment, the one or more wire-retaining features can also include a non-electrically conductive sheath and/or a polymer carrier, and the insulative material can include polyethylene.

In another embodiment, a wire carrier includes a length of insulative material, wherein the insulative material comprises one or more wire-retaining features, wherein the one or more wire-retaining features comprises at least one predetermined arrangement of hemispherical tabs in the insulative material, and wherein the one or more wire-retaining features enable retention of at least one wire in at least one predetermined, non-linear pattern.

In such an embodiment, the at least one predetermined arrangement of hemispherical tabs in the insulative material includes a sequence of approximately one-quarter (¼) inch diameter hemispherical tabs spaced approximately one and one-sixteenth (1 1/16) inches apart. Also, in such an embodiment, the one or more wire-retaining features comprises a sequence of approximately one-quarter (¼) inch support holes. In such an embodiment, the at least one predetermined, non-linear pattern includes an apex angle between approximately 20 degrees and approximately 135 degrees. Further, in such an embodiment, the at least one predetermined, non-linear pattern includes an apex angle between approximately 23 degrees and approximately 33 degrees (e.g., approximately 25 degrees). Also, in such an embodiment, the at least one predetermined, non-linear pattern includes two or more distinct apex angles and/or two or more distinct pitch spacing distances.

Additionally, in such an embodiment, the one or more wire-retaining features can also include a non-electrically conductive sheath and/or a polymer carrier, and the insulative material can include polyethylene.

In yet another embodiment, a wire carrier includes a length of insulative material, wherein the insulative material comprises one or more wire-retaining features, wherein the one or more wire-retaining features comprises at least one predetermined arrangement of circular holes in the insulative material, and wherein the one or more wire-retaining features enable retention of at least one wire in at least one predetermined, non-linear pattern.

In such an embodiment, the at least one predetermined arrangement of circular holes in the insulative material includes a sequence of approximately one-quarter (¼) inch diameter circular holes spaced approximately eleven-sixteenths ( 11/16) inches apart. In such an embodiment, the at least one predetermined, non-linear pattern includes an apex angle between approximately 20 degrees and approximately 135 degrees. Further, in such an embodiment, the at least one predetermined, non-linear pattern includes an apex angle between approximately 23 degrees and approximately 33 degrees (e.g., approximately 25 degrees). Also, in such an embodiment, the at least one predetermined, non-linear pattern includes two or more distinct apex angles and/or two or more distinct pitch spacing distances.

Additionally, in such an embodiment, the one or more wire-retaining features can also include a non-electrically conductive sheath and/or a polymer carrier, and the insulative material can include polyethylene.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment may provide a beneficial effect such as, for example, enabling a user to create an antenna much more quickly and efficiently than via existing approaches. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A wire carrier comprising:
a length of insulative material;
said insulative material comprising one or more wire-retaining features;
wherein said one or more wire-retaining features comprises at least one predetermined arrangement of notches in the insulative material; and
wherein said one or more wire-retaining features enable retention of at least one wire in at least one predetermined, non-linear pattern.

2. The wire carrier of claim 1, wherein said at least one predetermined arrangement of notches in the insulative material comprises a sequence of approximately one-eighth (⅛) inch by one-quarter (¼) inch rectangular notches spaced approximately twenty-one thirty-seconds ( 21/32) inches apart.

3. The wire carrier of claim 2, wherein said one or more wire-retaining features comprises a sequence of approximately one-quarter (¼) inch support holes.

4. The wire carrier of claim 1, wherein the at least one predetermined, non-linear pattern comprises an apex angle between approximately 20 degrees and approximately 135 degrees.

5. The wire carrier of claim 1, wherein the at least one predetermined, non-linear pattern comprises an apex angle between approximately 23 degrees and approximately 33 degrees.

6. The wire carrier of claim 1, wherein the at least one predetermined, non-linear pattern comprises two or more distinct apex angles.

7. The wire carrier of claim 1, wherein the at least one predetermined, non-linear pattern comprises two or more distinct pitch spacing distances.

8. A wire carrier comprising:
a length of insulative material;
said insulative material comprising one or more wire-retaining features;
wherein said one or more wire-retaining features comprises at least one predetermined arrangement of hemispherical tabs in the insulative material; and
wherein said one or more wire-retaining features enable retention of at least one wire in at least one predetermined, non-linear pattern.

9. The wire carrier of claim 8, wherein said at least one predetermined arrangement of hemispherical tabs in the insulative material comprises a sequence of approximately one-quarter (¼) inch diameter hemispherical tabs spaced approximately one and one-sixteenth (1 1/16) inches apart.

10. The wire carrier of claim 9, wherein said one or more wire-retaining features comprises a sequence of approximately one-quarter (¼) inch support holes.

11. The wire carrier of claim 8, wherein the at least one predetermined, non-linear pattern comprises an apex angle between approximately 20 degrees and approximately 135 degrees.

12. The wire carrier of claim 8, wherein the at least one predetermined, non-linear pattern comprises an apex angle between approximately 23 degrees and approximately 33 degrees.

13. The wire carrier of claim 8, wherein the at least one predetermined, non-linear pattern comprises two or more distinct apex angles.

14. The wire carrier of claim 8, wherein the at least one predetermined, non-linear pattern comprises two or more distinct pitch spacing distances.

15. A wire carrier comprising:
a length of insulative material;
said insulative material comprising one or more wire-retaining features;
wherein said one or more wire-retaining features comprises at least one predetermined arrangement of circular holes in the insulative material; and
wherein said one or more wire-retaining features enable retention of at least one wire in at least one predetermined, non-linear pattern.

16. The wire carrier of claim 15, wherein said at least one predetermined arrangement of circular holes in the insulative material comprises a sequence of approximately one-quarter (¼) inch diameter circular holes spaced approximately eleven-sixteenths ( 11/16) inches apart.

17. The wire carrier of claim 15, wherein the at least one predetermined, non-linear pattern comprises an apex angle between approximately 20 degrees and approximately 135 degrees.

18. The wire carrier of claim 15, wherein the at least one predetermined, non-linear pattern comprises an apex angle between approximately 23 degrees and approximately 33 degrees.

19. The wire carrier of claim 15, wherein the at least one predetermined, non-linear pattern comprises two or more distinct apex angles.

20. The wire carrier of claim 15, wherein the at least one predetermined, non-linear pattern comprises two or more distinct pitch spacing distances.
